(19) United States
(12) Patent Application Publication
(10) Pub. No.: US 2018/0077919 A1
(43) Pub. Date: Mar. 22, 2018

(54) Mobile, Remotely Controlled Animal Trap System

(71) Applicant: Jeffrey Wayne McNew, Greenbrier, AR (US)

(72) Inventor: Jeffrey Wayne McNew, Greenbrier, AR (US)

(21) Appl. No.: 15/818,149

(22) Filed: Nov. 20, 2017

Related U.S. Application Data
(63) Continuation-in-part of application No. 14/613,776, filed on Feb. 4, 2015, now Pat. No. 9,826,710.
(60) Provisional application No. 61/936,090, filed on Feb. 5, 2014.

(51) Int. Cl. A01M 23/20; A01M 31/00; G03B 29/00; H04N 7/18; H04N 5/33

(52) U.S. Cl. CPC A01M 23/20; A01M 31/00; H04N 5/33; H04N 7/188; G03B 29/00

(57) ABSTRACT

A portable, trapping system for capturing and non-lethally retaining a large number of large animals, such as wild horses or feral hogs. A specialized trailer aligns and secures deployable corral components for transportation. The corral comprises a modular fence erected on-site from multiple fence panels that are hinged together by pinning. The fence panels are configured with voids to prevent animal climbing. A circuit controlling a video camera communicates via cellular phone or satellite to remote locations for user-observation and trap control. A gate with a remotely actuated trap door is pinned between adjacent fence panels. The gate comprises a catch controlled by a circuit operated latch for remotely releasing the trap door via cell phone or Internet. A trailer with upper and lower aligned ceiling and floor channels constrains panels for transportation.

### CROSS-REFERENCE TO RELATED APPLICATION

This continuation-in-part utility patent application is based upon, and claims priority from, a prior pending U. S. utility patent application entitled “Mobile Configurable Animal Trap System,” Ser. No. 14/613,776, Filed Feb. 4, 2015, which was in turn based upon expired U.S. Provisional Patent Application, Ser. No. 61/936,090, filed Feb. 5, 2014, entitled “Modular, Trailerized Animal Trap System,” by inventor Jeffrey W. McNew, the entire disclosures of which are hereby incorporated by reference.

### BACKGROUND OF THE INVENTION

### I. Field of the Invention

The present invention relates generally to portable traps for capturing relatively large animals. More particularly, the present invention relates to remotely monitored and controlled trap systems including deployable corrals with fences and gates for capturing and temporarily restraining relativity large animals such as feral hogs, wild horses, or the like.

### II. Description of the Prior Art

So-called “Feral hogs”, while not native to the United States, present an increasingly dangerous problem. They are an invasive species, a public nuisance and a threat to Arkansas and other states. They compete for food resources, destroy habitat by rooting and wallowing, and they will eat ground-nesting birds, eggs, fawns and young domestic livestock. They also carry up to forty-five bacteria, diseases and parasites, including Trichinosis, Brucellosis and swine herpes virus.

The population of wild hogs in southern portions of the United States has increased significantly in recent years. Feral pigs have been harvested by hunting and shooting for the last few decades. Sport hunting of feral hogs has been more hindrance to hog removal than benefit. Hunting has been shown to reduce hog populations by only eight to fifty percent. The illegal relocation of hogs for hunting purposes has spread the problem to new areas. The shooting of individual hogs also thwarts large-scale trapping efforts by agencies because increased disturbance makes it nearly impossible to catch the whole family group at once.

Hogs can be chased away away from crops or food plots temporarily, but they soon return and quickly become a problem for landowners. Studies show that approximately two-thirds of a hog population must be removed each year just to prevent the population from growing. Wild hogs weighing in excess of five hundred pounds are commonly found in widespread areas of Texas, Louisiana and southern Arkansas. Reports of wild hogs weighing in excess of 1000 pounds within the southern United States are not infrequent. Feral hogs are large, strong and aggressive, and they are equipped with large tusks that can seriously injure a human being, particularly young children. Feral hogs often damage the local environment, and interfere with agriculture. Hogs require plentiful food, and their voracious appetite insures substantial competition with other wild animals, such as deer, or with domestic animals, such as cattle and horses, that are more desirable. Widespread areas of land, including recreational areas such as parks, hiking trails, and leased hunting grounds, commonly evidence the activities of large hog populations. In such areas the ground may be rooted up and visibly disturbed for hundreds of yards in every direction.

Thus feral hogs, and certain other non-game animals, have become dangerous nuisances. The Arkansas Game and Fish Commission recognizes large-scale trapping as the most efficient and economical means currently available to reduce feral hog populations. Of course, a variety of prior art traps and cages have been proposed for such use.

Often, trappers have relied upon large, preassembled cages that are bulky and difficult to handle and deploy. These often have square or rectangular shapes, with a gate or trap door disposed at one or both ends. As herds of feral hogs move about, however, the traps must be relocated and redeployed to follow the herd. However, most known preassembled cages are difficult to handle and relocate, so it can be a time consuming process for a trapper to actively follow meandering hog populations. Typical known designs have several shortcomings. Feral hogs are relatively intelligent, and quickly recognize the potential dangers to them of any trap system. Smaller traps can, in effect, scare off the majority of a herd. Where, for example, a conventional cage traps a single animal, the rest of the hogs often recognize the threat and leave the area. Of course, the damages that a trapped wild animal can inflict upon a poorly built or structurally weak trap are well known. However, where traps of conventional designs are merely reinforced and ruggedized, without substantial redesign, their increased weight and bulk interfere with mobility, and the potential speed realized by the trapper.

Another disadvantage of many prior art cages is that the trap door and associated tripping mechanisms are often unreliable. When engaged by a one thousand pound animal, for example, the door may be triggered while the animal has only partly entered the trap, facilitating escape. Another disadvantage of prior art devices is the difficulty in opening the door after the animal has been trapped inside. In order to release the door used with poorly designed, prior art cages, the trapper's body may closely encounter the trapped animal, resulting in potential attacks and injuries.

A typical cage trap is illustrated in U.S. Pat. No. 5,864,982, issued Feb. 2, 1999. This reference discloses a cage trap with a vertically disposed, sliding door at the trap front. A trigger mechanism linked to the door is activated by an animal contacting a bait pan that is placed within the trap. However, traps of this type cannot capture and confine a plurality of large animals such as feral hogs at once.

U.S. Pat. No. 5,199,210 issued Apr. 6, 1993 discloses a cage-type animal trap adapted to capture a single large animal at a time. An elongated, generally rectangular cage comprises roof and floor panels, side panels, and a rear panel. A forward portion has a vertically slidable door guided by tracks in the side panels that is gravity-actuated. Bait disposed within the cage toward the rear panel is supported by a retainer slidably disposed upon the roof panel. An elongated trip rod activated when an animal pushes the bait tray springs the trap and seals the cage. The door is released and moves downwardly in response to gravity. Again, a plurality of large animals cannot be handled all at once. Moreover, trip rods of this type may be broken or damaged by sudden impulsive moves of relatively large and ferocious animals such as trapped feral hogs.

U.S. Pat. No. 8,359,783 issued Jan. 29, 2013 discloses a a cage trap having an animal enclosure, with a remote-controlled trap door-opening mechanism. The mechanism is mounted outside the trap and is remotely activated by a transmitter to open a trap door and release a trapped animal when the operator is at a safe distance away.

Relatively large trap arrangements for capturing multiple feral hogs at once are known in the art. Many include a deployable fence comprising a plurality of interfitting, modular fence sections. For example, U.S. Pat. No. 6,772,555 issued Aug. 10, 2004 discloses a portable animal trap for humanely capturing and restraining large animals such as feral hogs. The trap may be field assembled from modular components, including a multi-section fence and an associated gate. Animals are attracted within the trap by bait. A sliding gate supported and released by a sliding gate latch traps the animals when triggered. The modular components comprise square or rectangular wire mesh panels framed by square tubing. Once the individual components are placed in their proper positions, they are joined together by fasteners.

U.S. Pat. No. 7,854,088 issued Dec. 21, 2010 discloses another trap for containing a number of relatively large animals. An entry path (game trail, etc.) extends from the enclosure to an automated drop gate at the entrance. At least one trip arm disposed along the entry can actuate the gate when contacted by animals. The trap is configured to capture a number of herd animals such as wild pigs.

U.S. Pat. No. 8,061,076 issued Nov. 22, 2011 discloses another portable large animal trap designed for capturing multiple wild hogs at once. The trap is firmly secured to the ground by a chain. When hogs or other large animals in the trap root up pins in the ground, the door drops and locks shut.

A variety of modular fence arrangements suitable for use with a large animal trap are known in the art for erecting temporary corrals or animal pens. Such modular fences are transported to a desired location and then deployed by coupling modular fence pieces together to form a temporary fenced enclosure. For example, U.S. Pat. No. 3,741,529 issued Jun. 26, 1973 shows a portable corral formed from a plurality of pivotally-intercoupled panels. The fence panels can be be folded into a compact assembly for transportation in a typical horse trailer. When the assembly is unloaded from the trailer, the several panels are connected in a desired configuration to form a temporary corral confining a desired area.

U.S. Pat. No. 3,767,167 issued Oct. 23, 1973 shows a portable fence panel designed for connection to identical panels to form a pen or corral. The generally rectangular panels are interconnected with one another by tubes mounted both at the top and bottom of posts that receive inverted studs mounted on an opposite end post on a companion panel. The studs on one panel end pivotally mate within registered tubes on the adjoining panels. By providing a trio of tubes, a four-way fence corner can be constructed.

U.S. Pat. No. 4,371,148 issued Feb. 1, 1983 shows an enclosure using multiple sections that can be pivotally interconnected together by hinges and moved to assume a variety of configurations. A circular enclosure can be made from adjacent, arcuate sections that are pivotally interconnected by spaced apart hinges. Multiple hinges including pins received in sleeves are employed to pivot connected sections.

U.S. Pat. No. 4,537,151 issued Aug. 27, 1985 discloses a portable corral comprising a plurality of panels which are rotatably coupled to each other by sleeves. The panels may be folded and mounted on a trailer for transportation to a selected site. Each panel has both horizontal and vertical members. Supporting legs furnishing support for the panels are locked in place by pins. For transportation the panels are folded and placed on a support plate fastened to the trailer.

U.S. Pat. No. 4,844,424 issued Jul. 4, 1989 shows a portable fence made from multiple rectangular sections coupled together with pins and sockets. The couplings are formed from parallel sleeves which are welded to the frame. When the outermost sleeves of the couplings on opposite ends of two adjacent frames are axially aligned and a pin is inserted to connect adjacent sections.

U.S. Design Pat. No. 552,751 issued Oct. 9, 2007 shows a modular corral component suitable for use in conjunction with portable corral or fencing structures.

The art also reflects improved transportation means for hauling multiple-component fences, traps, or corrals. For example, U.S. Pat. No. 5,280,944 issued Jan. 25, 1994 discloses a carrier for transporting fence panels which are supported between a pair of vertical support posts mounted on a trailer. An extensible alignment bar attached to a support post extends across the front of the fence panels to keep the fence panels aligned. Hooks wrap around the outermost fence panels to hold them together.

Other art pertaining to fence hauling arrangements and modified trailers is discussed in the various other patents referenced above.

As implied above, to trap large quantities of wandering feral hogs an easily deployable and readily transportable trap system must be employed. A reliable gate must be integrated within a system comprising multiple fence sections that can be rapidly deployed once a target area is reached. Conversely, when the trap is to be moved to a new location, the fence panels must easily disassemble, and an efficient transportation arrangement for the panels must exist. Cumbersome stacks or folded bundles of fence sections are difficult to lift and manipulate. Fence portions should be easily stored and secured within a trailer without excessive labor, and without wasting time. However, when traveling, the fence modules should be stably secured within a housing or trailer that is adapted to handle them efficiently, without vibrating and shifting about over the road.

When deployed the panels must easily hinge together and pin to ground for stability and speed. Importantly, erected fence portions of an adequate large animal trap must be strong and durable enough to withstand the pressure and forces encountered in response to feral hogs (or other large animals such as horses) that can weigh in excess of one thousand pounds. Particularly for feral hogs, the corral fence and gate components must be designed to prevent animal climbing and escape.

Moreover, to entice hogs to enter the trap, the entryway threshold preferably must be concealable, without sacrificing the structural integrity of the gate. In prior art designs the gate bottom forming the corral entryway threshold can normally be seen by animals. It should be appreciated that many animals, such as feral hogs, are afraid to traverse metal structures, especially when associated with traps, so hogs often refrain from entering such an enclosure. Thus, where there is visually apparent, man-made structure occupying the entranceway or the entranceway threshold of a trap or corral, the likelihood of capture is reduced. On the other hand, where deployable gates have hitherto been fabricated in an inverted-U shape, where there is no bottom cross-piece or structure to scare away animals, the structural integrity is compromised, and such designs cannot non-destructively restrain large, captured animals (i.e., in the 1000 pound and above category) without injury or damage.

### BRIEF SUMMARY OF THE INVENTION

This invention comprises a readily transportable, configurable trap system for capturing and non-lethally retaining a large number of large animals, such as feral hogs, wild horses, or the like.

The preferred trapping system comprises a mobile platform or other means for conveyance that transports a deployable corral for erection and deployment at a suitable trapping site. Preferably a custom trailer is utilized for transporting the apparatus. The corral is engineered for quick and easy erection and/or take-down, and it can be custom configured at a trapping site in a variety of sizes and shapes.

The preferred corral comprises a modular fence that is erected on-site from multiple fence panels that are deployed end-to-end and then hinged together. A gate assembly, comprising a trap door, is similarly coupled between a pair of fence elements. Preferably the gate assembly employs a concealable entrance threshold that does not scare the animals.

Stakes secure the fence panels to the ground to reinforce the corral and form a stable enclosure. Importantly the fence panels are stored in a highly stable and organized arrangement within the mobile platform that is especially designed for the quick storage and deployment of the preferred corral fencing and gates(s). In one form the preferred fence panels are designed with special voids or gaps, to prevent animal climbing and escape.

The preferred mode of transportation is with a specialized trailer. The preferred trailer comprises a rigid, upright confining frame structure adapted to constrain the various corral components in a stable, space-saving configuration. An elevated, channeled ceiling is disposed above a channeled floor. Fence panels slidably register within spaced apart upper and lower ceiling and floor channels, so they are maintained in a parallel spaced-apart configuration during transportation. Similarly, suitable upper and lower aligned channels slidably receive and then constrain the gate assembly during transportation.

Thus a basic object of my invention is to provide a heavy duty, user-configurable animal trap system that can be easily transported to a suitable site for rapid deployment in a desired shape, size and configuration.

Another important object is to provide a transportable and user-deployable trap that can be remotely monitored and activated. It is a feature of the invention that control and monitoring can be initiated by cell phone, satellite monitoring systems.

A basic object is to humanely trap large animals such as feral hogs, wild horses, and elk.

A related object is to trap large quantities of animals, particularly feral hogs, all at once.

Similarly, it is an important object of my invention to trap large feral animals without injury.

Another basic object is to provide a universal trap that is configurable and deployable for use with a large variety of domestic and wild animals.

Yet another basic object is to provide a mobile, custom configurable corral and trapping system utilizing the corral, that can be deployed in various sizes for capturing a variety of animals.

Another object is to provide a trap of the character described that can capture a plurality of relatively large and heavy wild animals, such as feral hogs, and which can reliably restrain them once caught without hurting the hogs, and without sustaining damage from them.

A related object is to provide a fence panel design suitable for traps of the character described that prevents feral hogs or other captured animals from climbing and escaping.

An important object is to provide a modified trailer specially adapted to transport and dispense a plurality of heavy duty modular fence components suitable for use with heavy-duty, deployable traps, corrals or fences.

Another object is to provide a trap system of the character described that facilitates rapid and easy erection of fences or corral-type enclosures of a variety of user-selectable sizes and shapes.

A related object is to provide a trap system of the character described, and a customizable corral for the trap system, that can be adapted rapidly to different terrains and irregular ground.

Another object is to provide a portable fence and corral system for confining livestock or other large, domestic animals.

Another object of the present invention is to provide a portable, modular trap comprising a user-deployable fence structure that can be assembled into straight or curved portions as conditions necessitate.

It is also an object to provide portable fence panels of strong, durable construction, which are capable of being quickly, pivotally connected to cooperating panels, to provide a holding pen or enclosure for a variety of animals, whether domestic or wild.

A related object is to provide a gate system for use with the aforesaid fence panels that has a disguised or conceivable threshold, so that target animals are not frightened away.

Another object is to provide a portable fence panel system designed such that erection or disassembly can be accomplished by a minimum of workmen in a minimum of time.

Another basic object of the invention is to provide a portable fence panel system which can form rectangular and polygonal pens of desired sizes and shapes.

Yet another object is to provide a portable fencing system for temporarily deploying holding pens, field corrals, temporary stalls, and the like for a variety of animals.

Another important object of the present invention to provide a trap of the character described which has a reliable trigger mechanism.

Still another object of the invention is to provide a deployable, modular trap which has strength comparable to a cage trap, but which can be custom configured and deployed for capturing a large number of animals all at once.

It is another object of this invention to provide an improved, portable folding fence system of the character described wherein the transportation means, i.e., a trailer, is customized to quickly store and stabilize individual panels when transported.

These and other objects and advantages of the present invention, along with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is an isometric view of the preferred corral associated with the trap system, showing it deployed with the trap door in a set or open position, and with the fence elements deployed in one of a variety of possible, geometric configurations;

FIG. 2 is an isometric view similar to FIG. 1, but showing the trap door closed, as it appears after the trap system is triggered;

FIG. 3 is an enlarged, isometric view showing a preferred fence panel of the type preferred for large animals such as feral hogs;

FIG. 4 is an enlarged, fragmentary isometric view illustrating assembled, adjacent fence panels;

FIG. 5 is an enlarged, fragmentary, isometric view of a portion of the hinge area taken generally from circled region “5” in FIG. 4;

FIG. 6 is an isometric view of one form of a gate and a sliding trap door;

FIG. 7 is an enlarged, fragmentary isometric view taken generally from circled region “7” in FIG. 6;

FIG. 8 is an enlarged, fragmentary isometric view taken generally from circled region “8” in FIG. 6;

FIG. 9 is a fragmentary, rear isometric view showing a preferred panel proximate a game feeder, the panel supporting a solar collector, a video camera and a communication device;

FIG. 10 is a fragmentary, front isometric view of the apparatus of FIG. 9;

FIG. 11 is an enlarged, fragmentary isometric view derived generally from circled region “11” in FIG. 10;

FIG. 12 is a view similar to FIG. 10, but showing a satellite communication dish;

FIG. 13 is a rear view similar to FIG. 9, but showing the satellite communication dish;

FIG. 14 is a frontal elevational view of the preferred trap door controller cabinet;

FIG. 15 is a frontal elevational view of the controller cabinet with the face plate removed, showing the cabinet interior and major electrical parts;

FIG. 16 is a fragmentary, isometric view of the preferred system trailer, showing it unloaded;

FIG. 17 is a fragmentary, frontal isometric view of the unloaded trailer;

FIG. 18 is a fragmentary rear isometric view of the unloaded trailer;

FIG. 19 is a fragmentary isometric view of the unloaded trailer;

FIG. 20 is a fragmentary, rear plan view of the trailer, showing it loaded;

FIG. 21 is a fragmentary, rear plan view of the loaded trailer;

FIG. 22 is a fragmentary, isometric view of the loaded trailer;

FIG. 23 an isometric view of a trailer floor or ceiling showing the channels between which fence panels are slidably fitted;

FIG. 24 is a top plan view of the typical floor or ceiling;

FIG. 25 is a sectional view of a floor panel taken generally along line 25-25 in FIG. 23;

FIG. 26 is a block diagram of the preferred electronic control system using a separate modem and router;

FIG. 27 is a block diagram of the electronic control system using a combined modem and router;

FIG. 28 is a block diagram of the preferred satellite control system using a separate modem and router;

FIG. 29 is a block diagram of the satellite control system using a GSM cellular system with a separate camera;

FIG. 30 is frontal isometric view of an alternative embodiment of a corral with a roof;

FIG. 31 is an enlarged, fragmentary isometric view of the roof embodiment of FIG. 30, showing a roof panel fastening clamp;

FIG. 32 is a rear isometric view of the alternative embodiment of FIG. 30;

FIG. 33 is enlarged, fragmentary isometric view derived from circled region 33 in FIG. 32;

FIG. 34 is a plan view of an alternative door shown in the closed position; and,

FIG. 35 is a plan view of an alternative door shown in the open position.

### DETAILED DESCRIPTION OF THE DRAWINGS

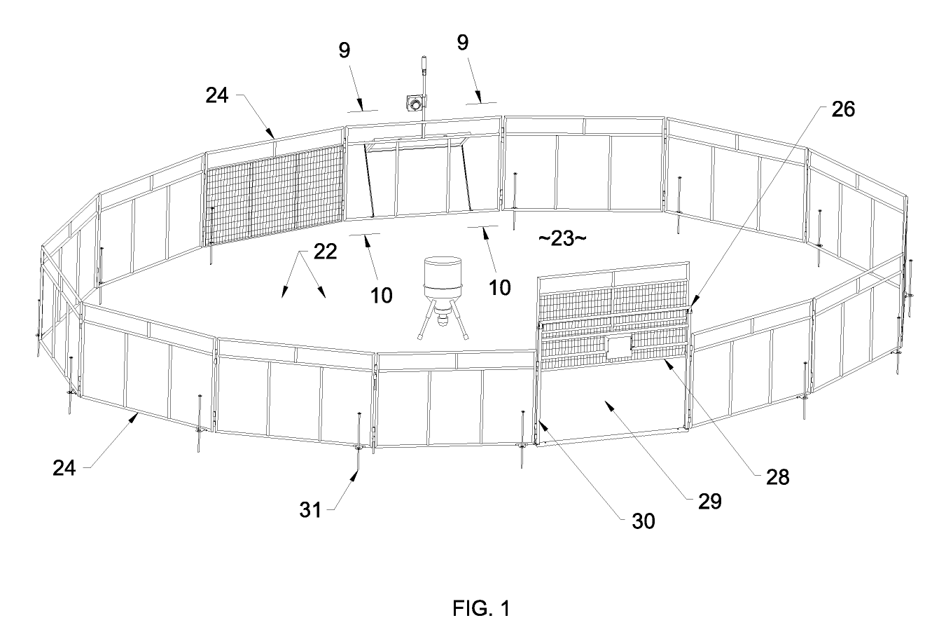

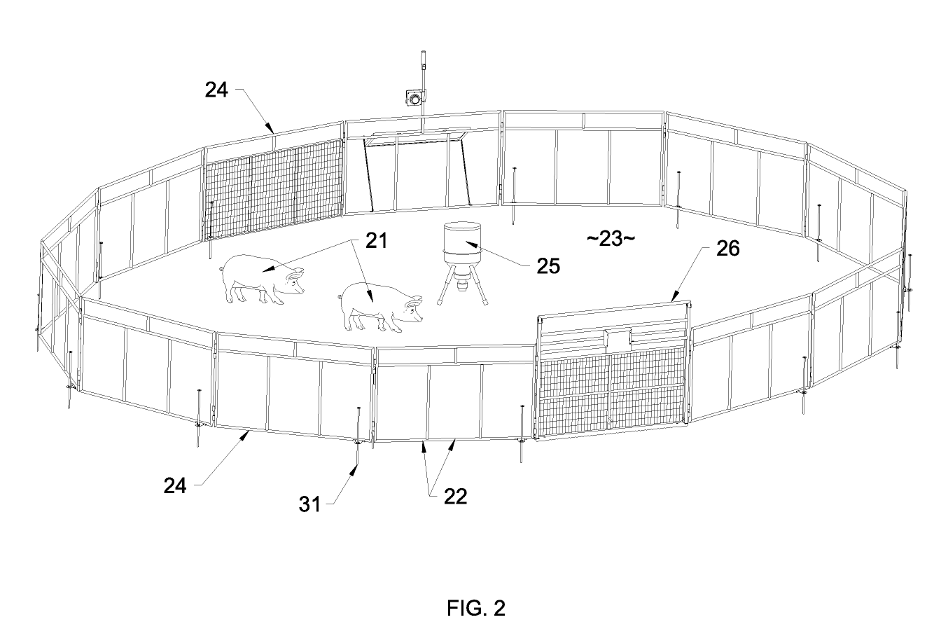

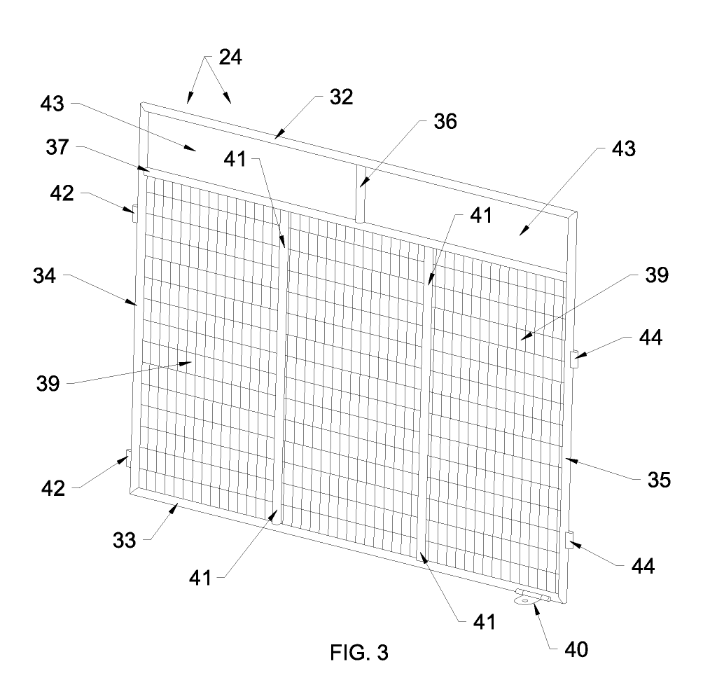

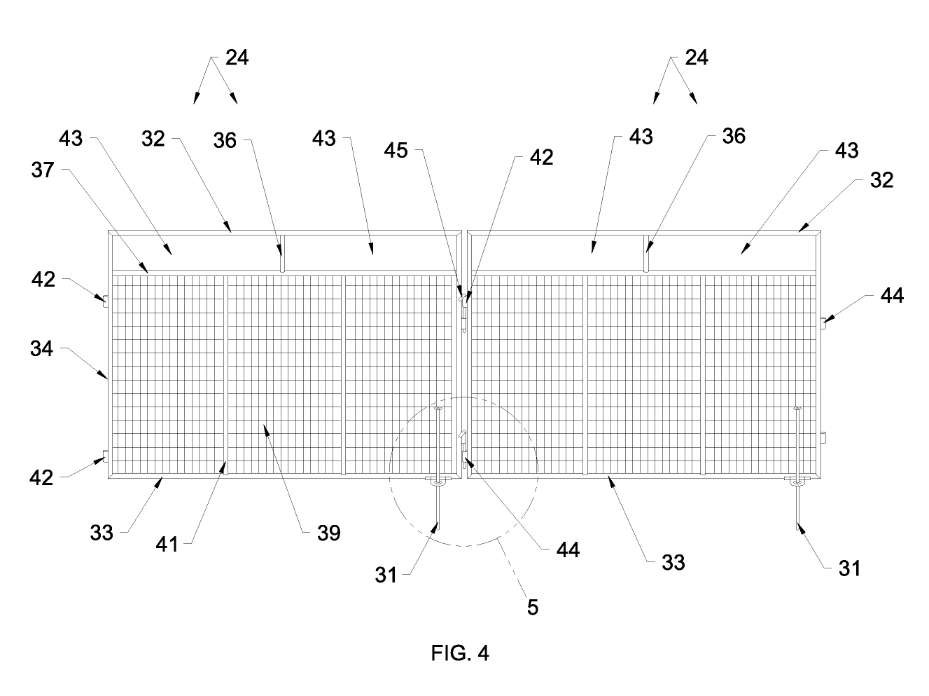

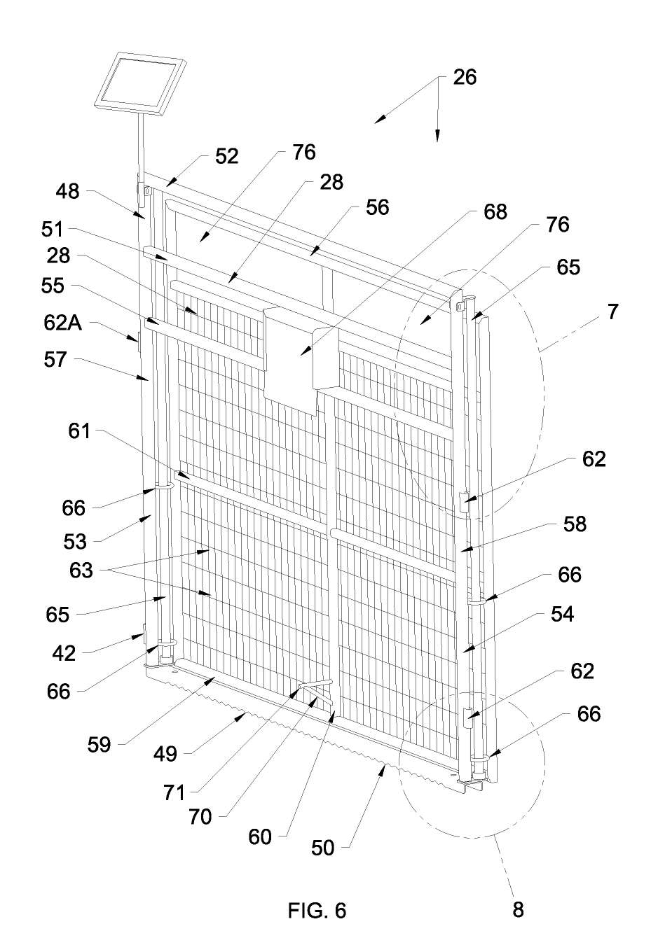

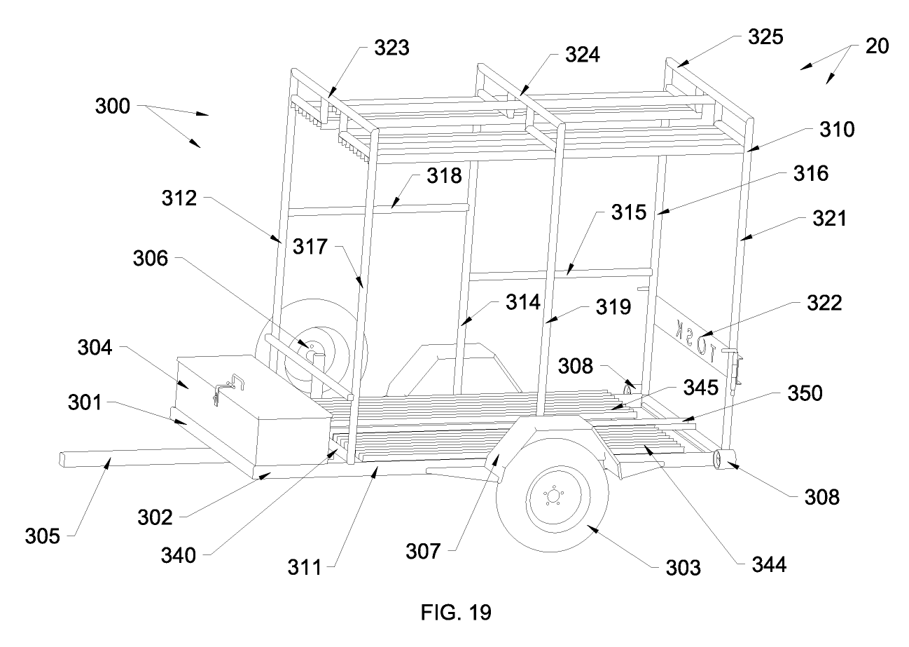

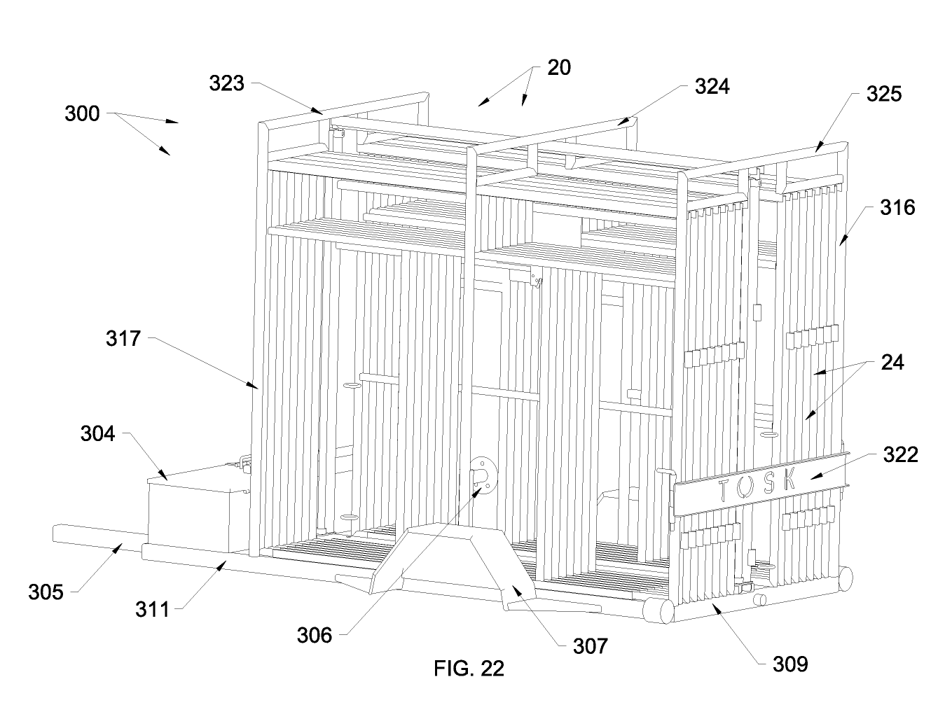

With initial reference now directed to FIGS. 1, 2, and 20-22 of the appended drawings, a preferred, remotely controlled and monitored, portable animal trap system constructed in accordance with a preferred mode of the invention has been generally designated by the reference numeral 20. The system 20 comprises a modular corral 22 (i.e., FIG. 1) and a mobile platform preferably afforded by a support platform or trailer or other conveyance for transportation, stowage and rapid delivery. The corral 22 is ideally deployed upon a somewhat flat area of deployment 23 at selected trapping location after transportation by trailer or 300 (i.e., FIG. 19) When unloaded and deployed, the corral 22 encircles area 23 to form a pen in which target animals, such as feral hogs 21 (FIG. 2) may be restrained after capture. A dispenser 25, that can discharge animal feed, animal scents, or other animal attractant, may be disposed and confined within area 23. The feeder dispenses attractant and is controlled through cellular controls. The corral 22 (FIGS. 1, 2) is assembled after unloading from a plurality of interlinked, modular fence panels 24 (FIGS. 3, 4) that occupy and define a corral periphery, along with various accessories and at least one slidable gate described later (FIGS. 6-8). The anti-climbing fence panels 24 are preferred for feral hogs which are very adept at climbing over conventional fences and panels.

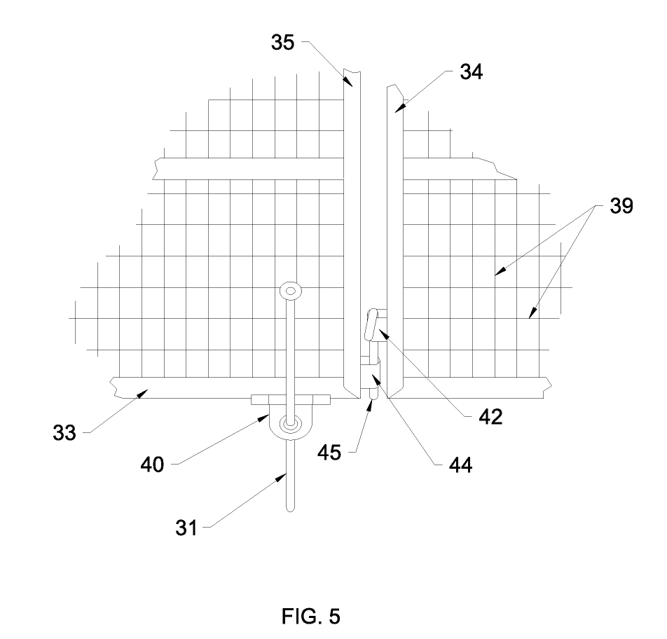

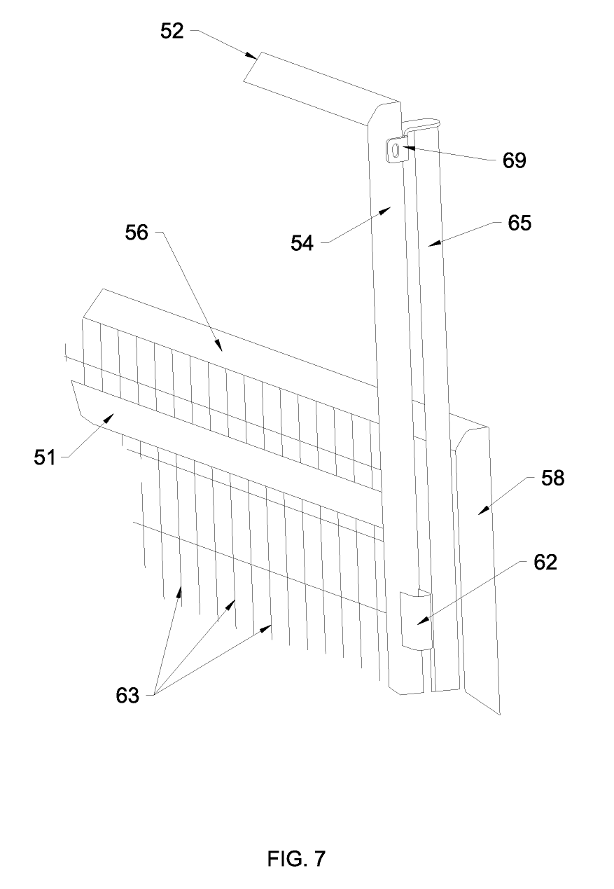

Preferably the various fence panels 24 are generally rectangular, as best seen in FIG. 3. Each fence panel 24 has opposite ends provided with hinge structure explained and illustrated in conjunction with FIGS. 4 and 5 that pivotally couple adjacent panels together when the corral 22 is deployed. The corral 22 surrounds enclosed pen area 23, access to or from which is enabled or foreclosed by a gate 26 (i.e., FIGS. 1 and 6) that supports a slidable trap door 28 that selectively blocks a normally open corral entryway 29 (FIG. 1) through which target animals pass. Door 28 is slidably captivated between gate sides 30 (FIGS. 1, 7) on opposite sides of entryway 29. Gate 26 and trap door 28 are detailed hereinafter. During installation, the fence panels 24 (and thus the resultant corral 22) are preferably secured to the ground by a plurality of stakes 31 (FIGS. 1, 2) that are driven into the ground during corral erection around area 23.

As best seen in FIG. 3, a typical fence panel 24 comprises a rigid, generally rectangular structure comprising an elongated, rigid top rail 32 and a spaced-apart, parallel bottom rail 33 that are braced together with parallel end rails 34 and 35. Larger fence panels between four to six feet tall, are preferred for trapping larger animals such as wild horses and large feral hogs. Intermediate rail 37 is disposed between upper rail 32 and bottom rail 33. Reinforcement is provided by a small, vertical cross rail 36 extending between rails 32 and 37, and further reinforcement is provided by larger vertical rails 41 (FIG. 1). Screened or webbed panel sections 39 are defined between the various rails 33, 34, 35, 37, and 41. Each panel bottom rail 33 is preferably provided with a hinged stake tab 40 (FIGS. 3, 3) through which stakes 31 (FIG. 4) may be driven to secure the deployed corral around the ground proximate area 23. The tab 40 is deployed perpendicularly to the fence panel when a stake is installed. To enhance clearance, the tabs 40 may be deployed vertically (i.e., flushly aligned with the plane of a fence panel) when the fence panels are stowed or transported.

Preferred fence panels 24 have been designed to prevent hogs from climbing to escape capture. There is an approximately ten to twelve inch gap between top rail 32 and intermediate rail 37. Preferably the distance between top rail 32 and intermediate 37 is between ten to twenty five percent of the distance between bottom rail 33 and top rail 32. Anti-climbing voids 43 are defined between the various panel rails 32, 34, 35, 36 and 37. It has been found that these anti-climbing voids make it virtually impossible for feral hogs 21 to climb over the panels 23 and escape the corral 22.

Means are provided for removably coupling adjacent fence panels together. It is preferred that panels be hinged or pivotally coupled together through some form of elongated coupling such as a pin, hook, locking brace, clevis or the like. Preferably, at the left of each fence panel 24 there are a pair of rigid, vertically spaced apart sleeves 42 that are welded to end rail 34. There are a pair of similar spaced-apart sleeves 44 on the right side of each panel 24, welded to end rail 35. Sleeves 44 are vertically spaced apart from one another the same distance that sleeves 42 are spaced apart; however, sleeves 44 are lower than sleeves 42 so that, when two fence panels 24 are placed side-by-side, as illustrated in FIG. 4, the sleeves 42 on one panel 24 will axially, vertically align with spaced-apart sleeves 42 on a neighboring panel 24, so that they may be flexibly or pivotally joined together with removable, generally “L-shaped” pins 45 (FIG. 5.)

Referencing FIGS. 6-8, the rigid gate 26 is generally rectangular. It supports a reciprocally displaceable trap door 28 that closes or opens the corral by blocking or unblocking the corral entranceway 29. The gate 26 comprises a rigid, supporting frame 48 with an optional, rigid, elongated, concealment piece 49 at the gate bottom. Concealment piece 49, which occupies the entranceway threshold, has a jagged, bottom edge 50 that can be hidden within the ground. Thus, with the instant design, the gate bottom is concealable. During the corral erection process, the gate 26 may be moved into place and then manually moved back and forth like a saw, such that the edge 50 digs piece 49 into the ground for hiding the lower structure of the gate for concealment within the entryway threshold. Thus threshold concealment piece 49 hides the bottom of the gate to avoid scaring the animals or hogs away from the corral entryway.

Gate frame 48 supports an upper, rigid, top piece 52 (FIG. 6) that extends between rigid, spaced-apart frame sides 53, 54 (FIGS. 6, 7). As with the fence panels 24 discussed earlier, there are parallel, gate frame reinforcement cross pieces 51, 55. Gate frame side 53 has a pair of spaced apart sleeves 62A that function the same as sleeves 42 on a fence panel 24. Also, gate frame 48 has spaced apart sleeves 62 on its side 54 that are equivalent to sleeves 44 so that the gate 26 may be coupled to adjoining fence panels 24 the same way that 31 the fence panels are coupled together (i.e., with pins 45) as previously described.

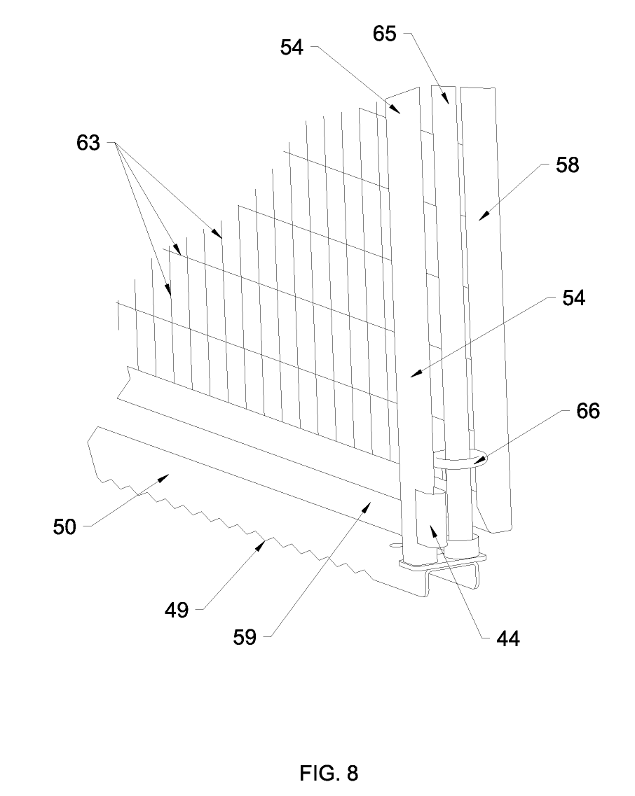

The gates'slidable trap door 28 comprises a rigid top rail 56 extending between sides 57 and 58 and a rigid bottom 59. There are vertical cross pieces 60 and horizontal cross pieces 61 for reinforcing the trap door 28. Webbing 63 exists between various sides and cross piece reinforcements. Preferably the gate frame 48 supports a pair of offset slide tubes 65 (FIG. 7) that are secured by suitable brackets 69 (FIG. 7). The trap door sides 57 and 58 each support slide rings 66 (FIG. 8) that are slidably captivated on slide tubes 65 so that the trap door 28 is displaceable vertically. Slide rings may alternatively be placed on the gate frame, with corresponding slide tubes on the trap door. When triggered (FIG. 8), the gate's trap door 28 may quickly slide down from the “set position” of FIG. 6 to forcibly close the gate in response to gravity.

Preferably trap door 28 is designed to prevent hogs from climbing over it. The anti-climbing trap door 28 is provided with a pair of ten to twelve inch high, spaced apart gaps 76 (FIG. 6). Gaps 76 function as anti-climbing voids like those discussed with the panels. They make it difficult for a feral hog to climb over the deployed gate 28 and escape.

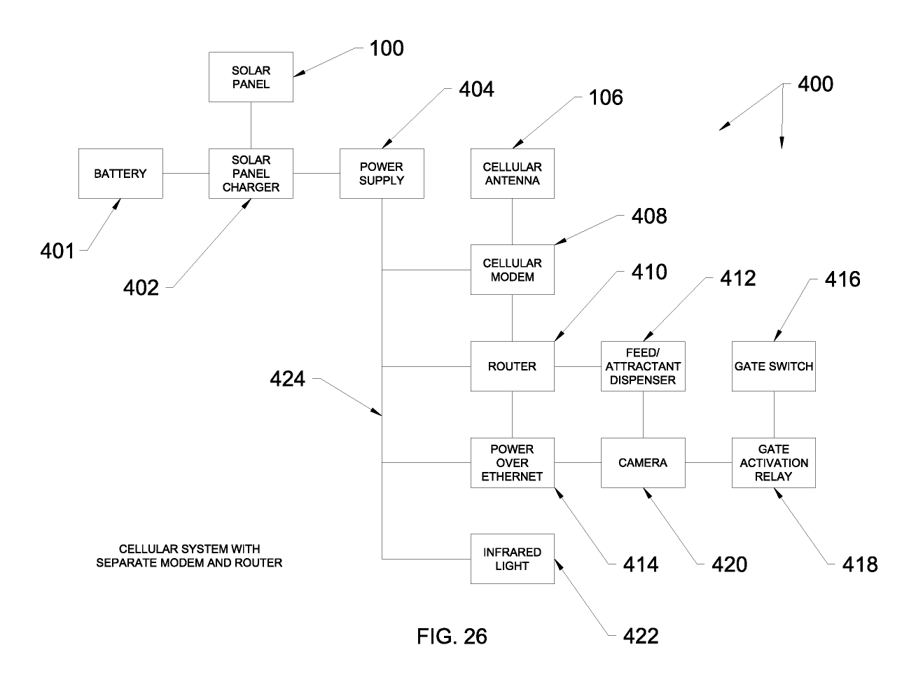

Trap triggering can be effectuated manually, through animal contact, or preferably through remote control. Block diagrams of the remote control systems are seen if FIGS. 26-29 discussed in more detail below. Preferably, trap triggering and gate actuation is controlled by a commercial gate controller.

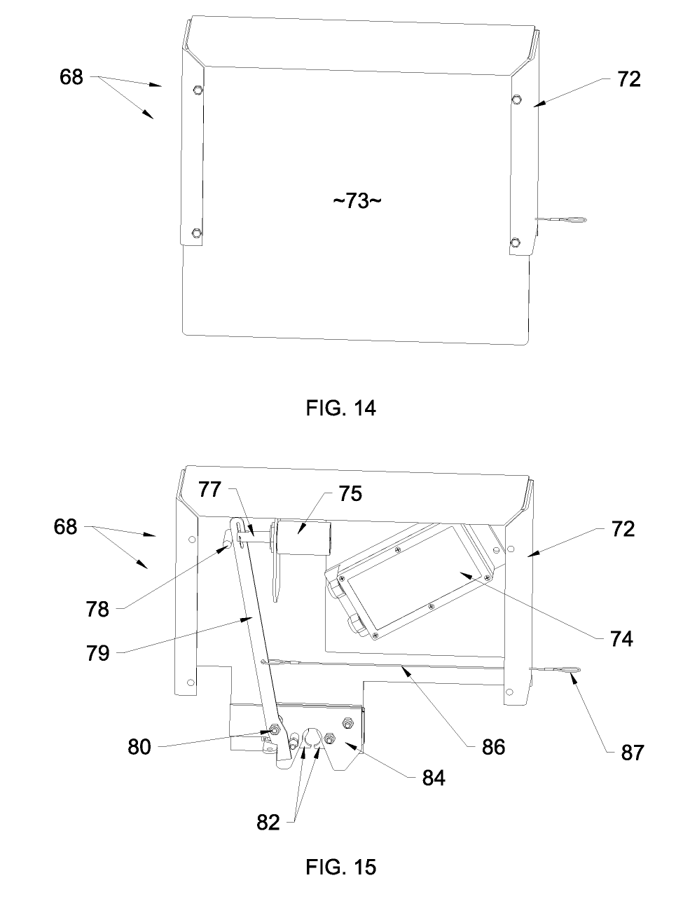

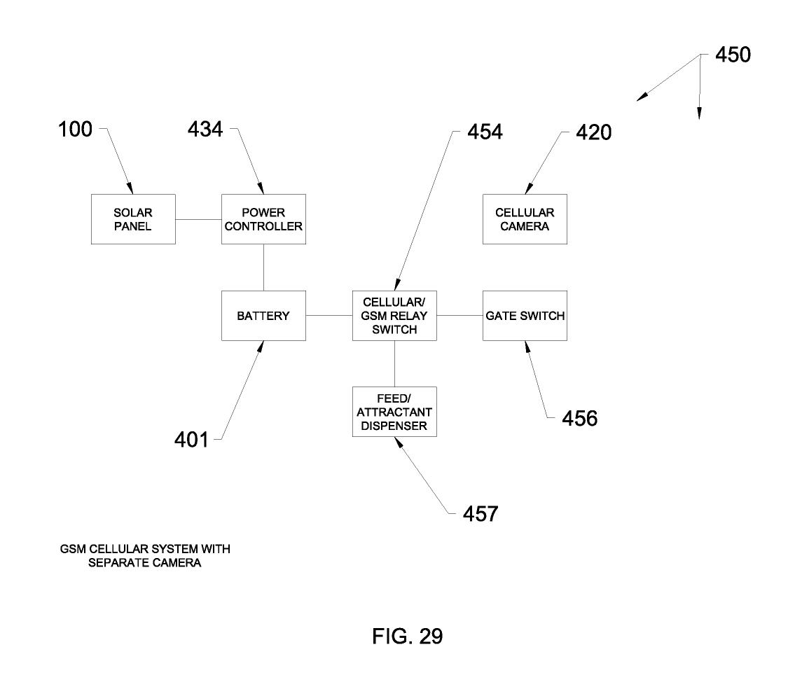

The preferred “cell phone mode” is illustrated in FIGS. 15 and 29. A controller housing 68 (FIGS. 14, 15) is secured to gate frame cross piece 51, 56 (FIG. 6). The housing 68 includes a GSM (i.e., Global System for Mobile Communication) having a remotely-activated switching unit 74 that ultimately controls a cell-phone activated latch release. (The GSM is denominated “454” in FIG. 29). The controller 68 has cabinet edges 72 (FIG. 15) that mounts removable face plate 73. In operation GSM 74 can release trap door 28 that is normally held by engaging a clasp structure 70 (FIG. 6) when the trap door is pen. The gate trap door has a rigid, catch 71, preferably comprising a pin that projects horizontally outwardly from the trap door 28 from cross piece 60.

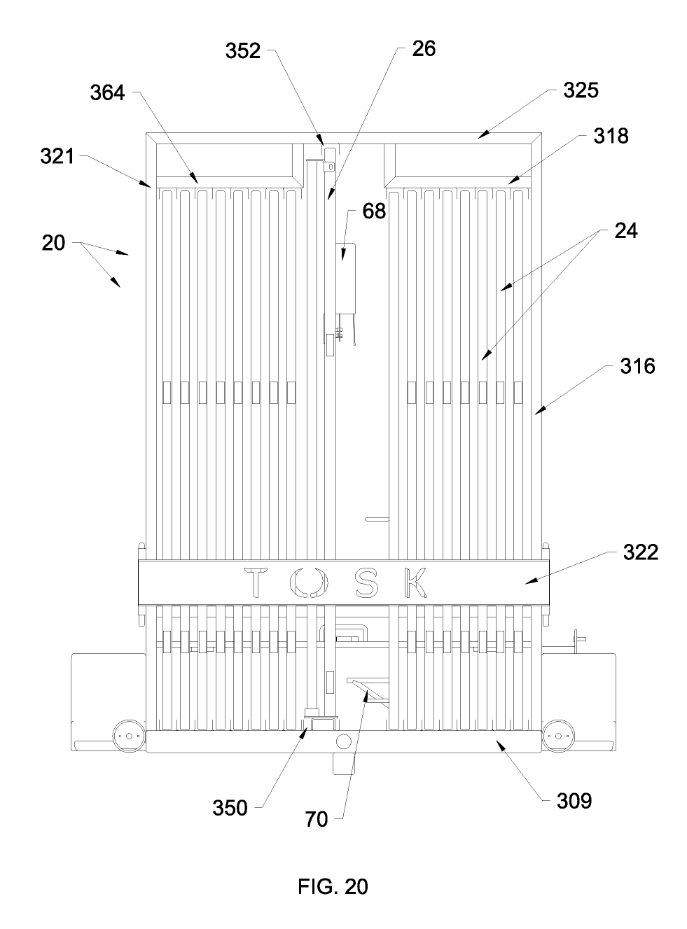

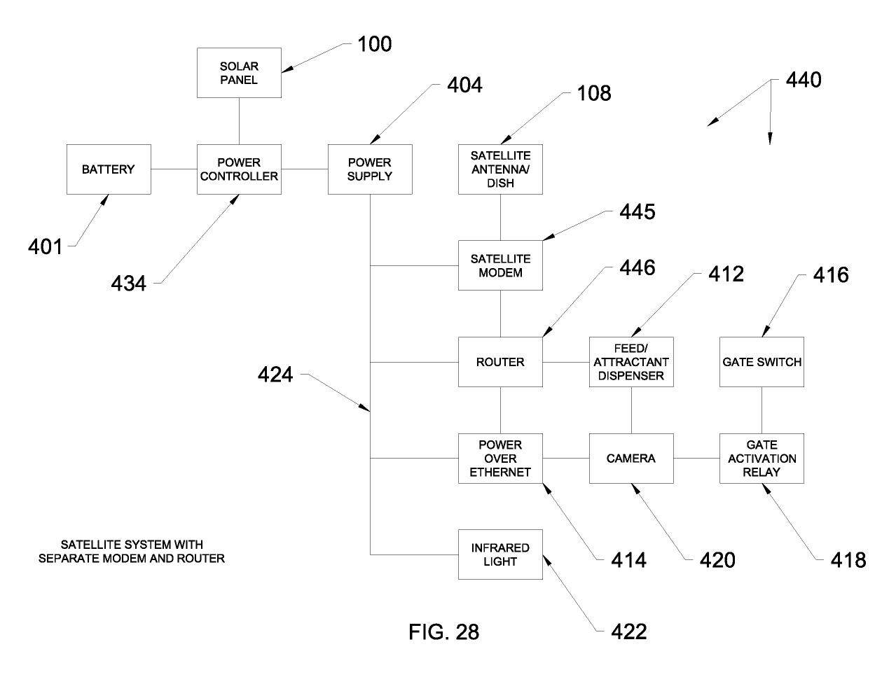

The GSM remotely-activated switching unit 74 controls a solenoid 75 (FIGS. 15) to retain or drop the trap door 28. The solenoid 75 activates a plunger 77 connected to a lever 79 that is pivoted at fastener 80. (In other embodiments, i.e., FIGS. 26, 27, and 28) a GSM is not used. Plunger displacement is limited by a stop 78 (FIG. 20). The gate latch mechanism 84 (FIG. 15) has jaws 82 controlled by lever 79 can grip catch pin 71 (FIG. 6) to retain the trap door 28 in the upper, open position (i.e., FIG. 1) when desired. The jaws 82 are normally spring biased together. When GSM 74 activates solenoid 75 to retract plunger 77, lever 79 deflects and forces jaws 82 apart, freeing catch pin 71 on the trap door which then drops, closing the gate. Controller 68 can be activated by a cell phone from a distance as described hereinafter. When trap control is accomplished through a satellite link, the than by cell phone, GSM 74 is not used. Instead, as seen in FIG. 28, a gate switch and gate relay described below are employed to activate trap.

An optional, manual release cord 86 (FIG. 20) coupled to lever 79 extends exteriorly from the cabinet interior, terminating in manually graspable handle portion 87. For manually triggering the trap or releasing the gate, handle portion 87 may be manually pulled, either directly or through a suitable elongated extension tied to portion 87. Suitable conventional animal-activated trip wires or trip mechanisms may be connected to handle portion 87 as well, to deflect cord 86 for triggering. However, the last mentioned type of triggering arrangement is not preferred because trap activation may occur when only a single animal is in the corral, defeating the trap's purpose of capturing numerous animals at once.

The controller 68 releases the trap door 28 upon a suitable signal or activation command programmed by the user either through a cellular telephone, radio connection, or through direct “hands on” activation. Because of the design of the trap, numerous hogs 21 (FIG. 2) can enter the trap, and hogs will not become “spooked” and leave or run away when slightly agitated. This means that large numbers of hogs 21 can be trapped at once, and capturing them is enhanced by remote cell phone control and monitoring. When using remote, cell-phone activation, the user may be watching the trap through a remote monitor TV camera also interconnected via cell phone.

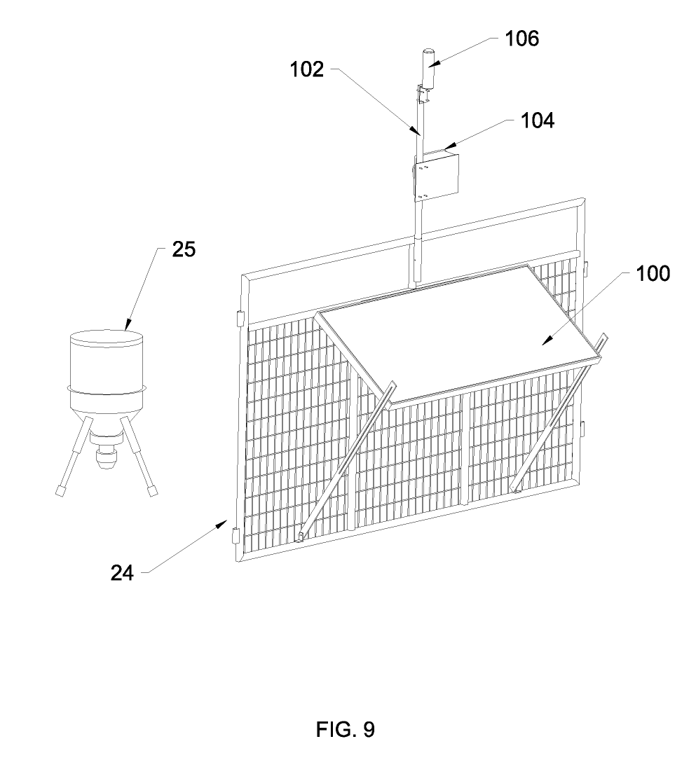

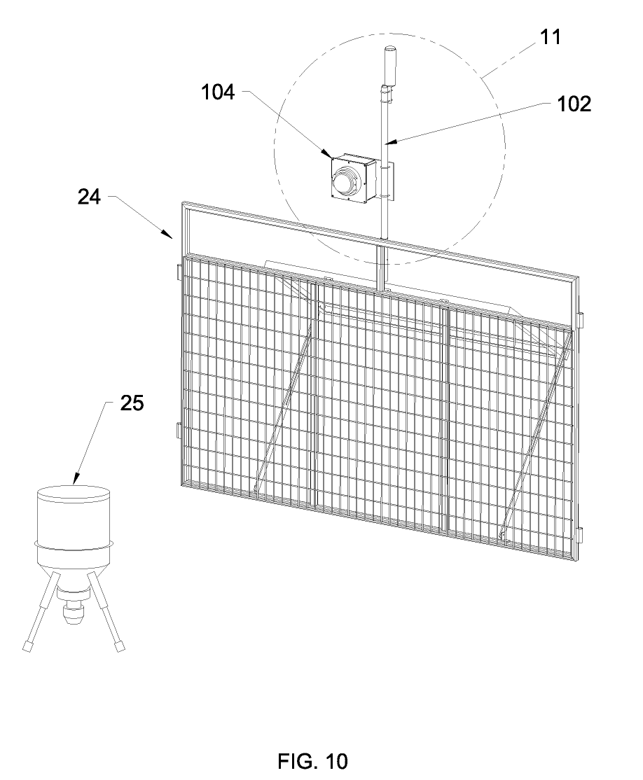

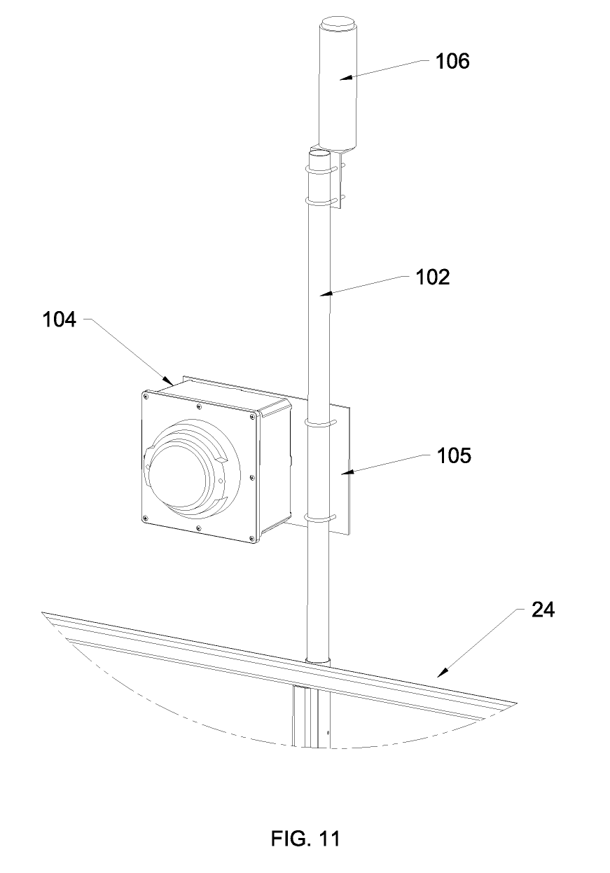

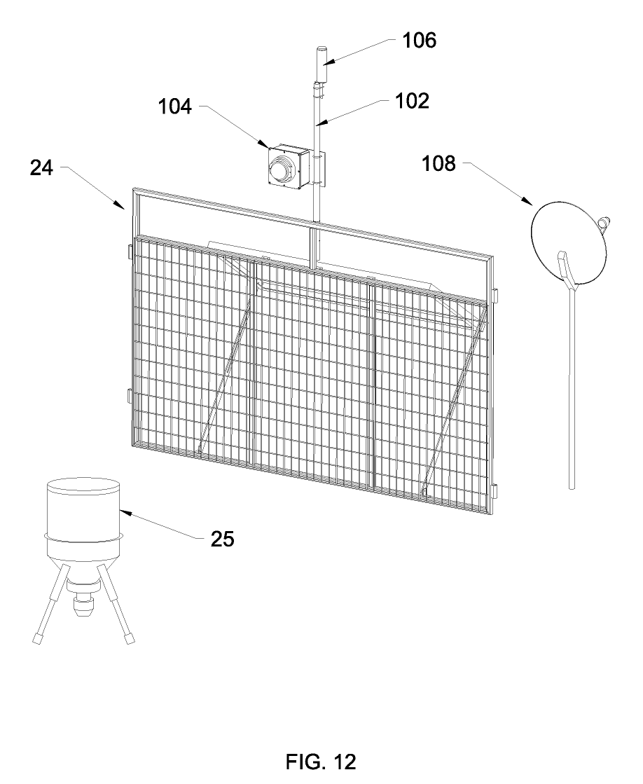

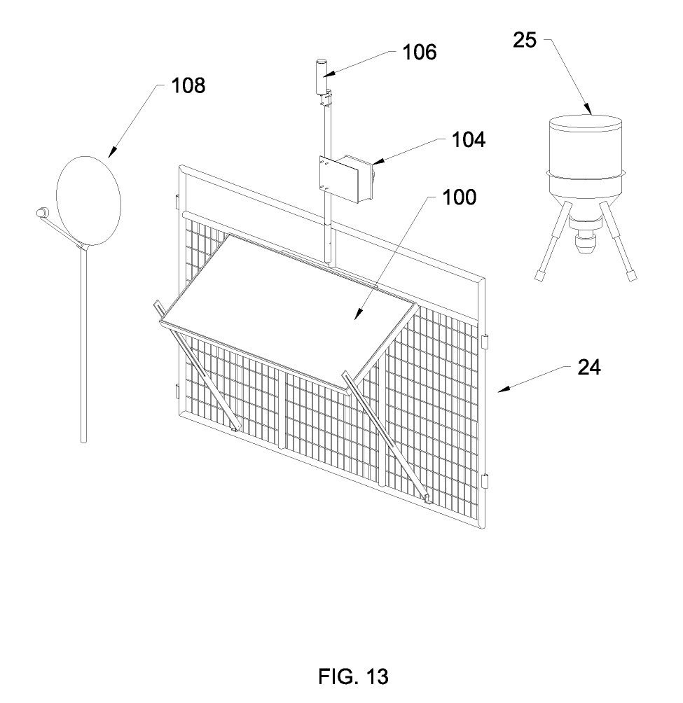

Referring jointly now to FIGS. 9-11, at least one corral panel 24 supports a solar panel 100 exposed to sunlight for charging the electronics described hereinafter. It will be noted that an upright stanchion 102 supports a suitable remotely actuable video camera 104 secured to stanchion 102 by a suitable mounting plate 105. Sitting atop stanchion 102 is a cell phone antenna 106 providing a link as described below. A satellite-communication dish 108 is also provided. The remote camera 104 sends pictures to a designated recipient and when they want to activate the gate latch mechanism to close the gate and capture the animals, they call the GSM phone number which activates the relay and drops the gate.

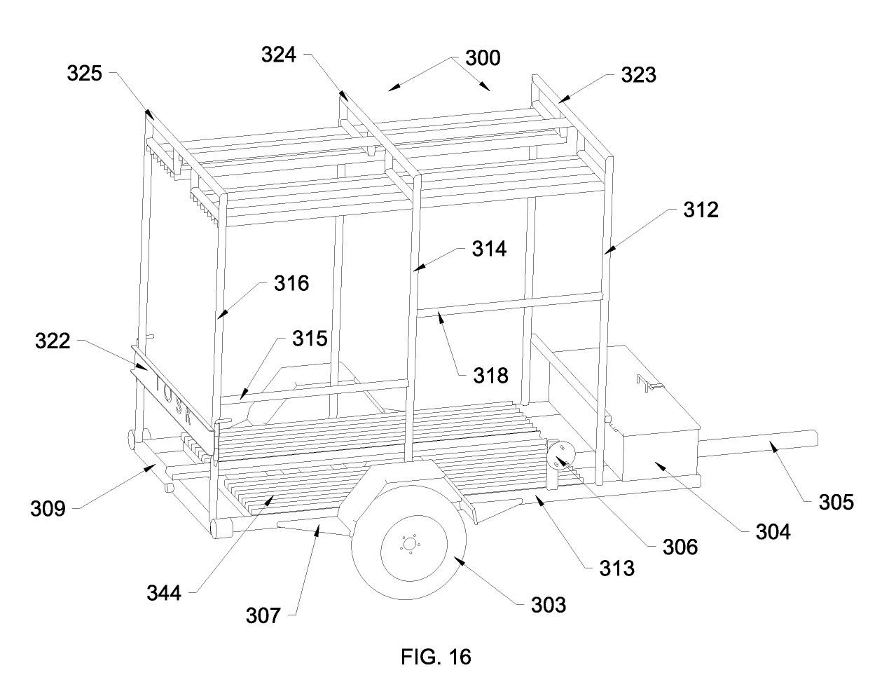

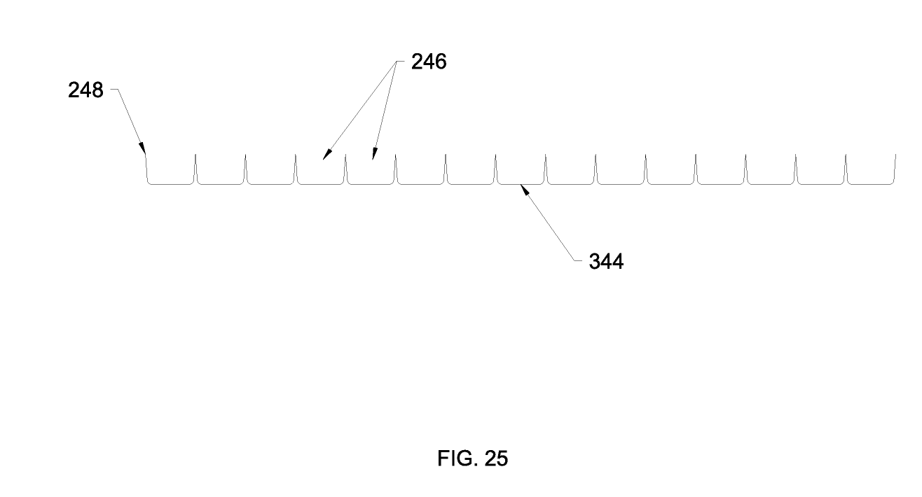

The instant trap system 20 comprises a mobile platform for storing and transporting its parts. Such a platform could be provided by a modified truck, a suitable trailer, or even a boat where feral animals are to be trapped upon river islands, which is a common practice along the Arkansas, Ouachita, and/or Mississippi rivers. However, with reference now directed generally to FIGS. 16-25, a preferred trailer is generally designated by the reference numeral 300. The various parts of corral 22, including the fence elements 24, the gate 26 and other parts are all neatly and stably stowed within trailer 300. In FIGS. 16-19 trailer 300 is shown unloaded, and trailer 300 is shown loaded in FIGS. 20-22.

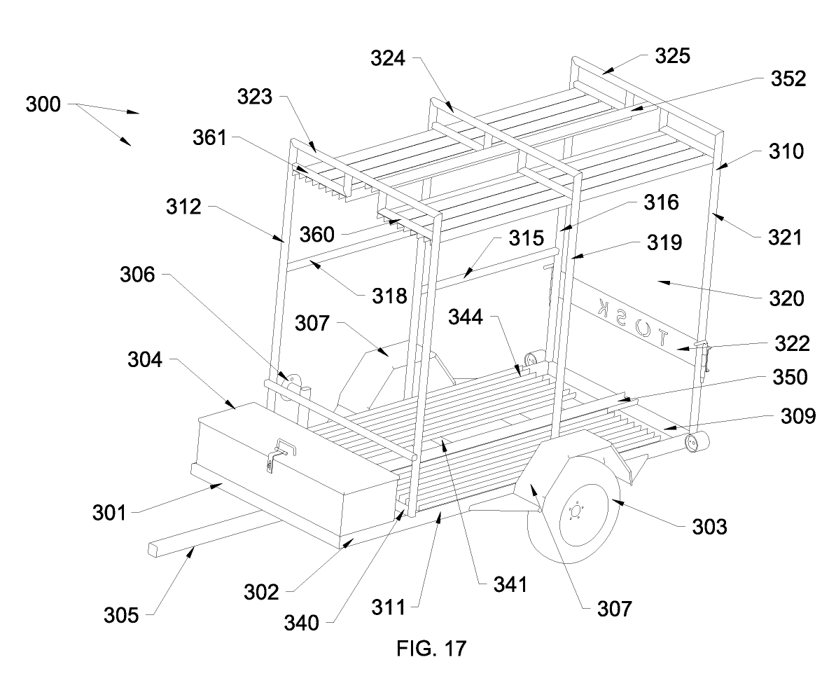

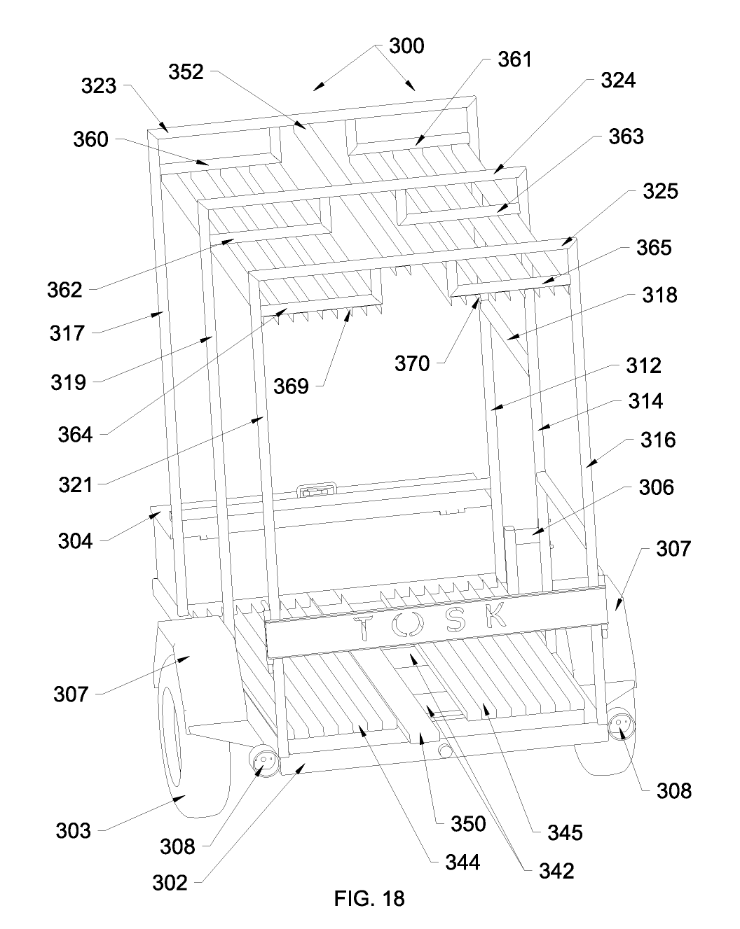

Trailer 300 comprises a rigid, generally rectangular, frame 302 (FIG. 17) comprising a rigid, transverse front portion 301 (FIG. 17), rear portion 309 (FIG. 17), and parallel frame sides 311 (FIGS. 17) and 313 (FIG. 16). Frame 302 has at least one wheeled axle 303 assembly that is shrouded by conventional fenders 307 (FIG. 18). A conventional trailer tongue 305 interconnects with a suitable towing vehicle. Preferably trailer 300 has a front-mounted storage box 304, and a front-mounted spare tire carrier 306 that are welded to the frame 302. Conventional taillights 308 are welded at the trailer rear (i.e., FIG. 18).

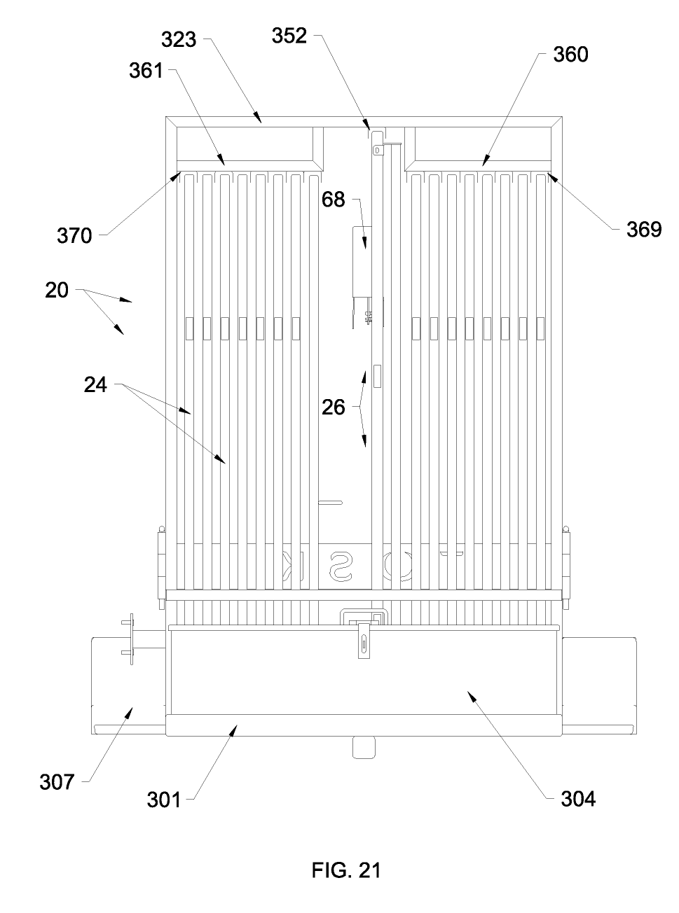

A rigid, confining frame structure, generally indicated by the reference numeral 310 (i.e., FIG. 17) extends vertically upwardly from frame 302. The right side of the vertical frame structure 310 (i.e., as viewed in FIG. 16) comprises a trio of rigid, vertically spaced apart, stanchions 312, 314, and 316 (i.e., FIG. 19) rising upwardly from frame 302. The left side includes another trio of upright, perpendicular stanchions 317, 319, and 321 (i.e., FIG. 18) that form and reinforce the opposite side of the trailer 300. The left side stanchions 317, 319 and 321 are generally aligned with and parallel with the right side stanchions 312, 314, and 316 respectively, and with trailer 300, the left side stanchions are substantially equal in length to the right side stanchions. Preferably there is a transverse reinforcement strut 318 (FIG. 17) bracing the apparatus and extending between side stanchions 312 and 314. A similar transverse reinforcement strut 315 (i.e., FIG. 19) extends between stanchions 314 and 316. A detachable rear panel 322 selectively closes the trailer and braces the trailer rear (i.e., FIG. 21) after loading. An optional, selectively deployable antenna mount 320, which is pivoted to stanchion 321 at the trailer left side and selectively latched to front stanchion 317, can support the necessary antenna for controller 68.

At the trailer top the vertical confining frame structure 310 has uppermost horizontal struts 323, 324, and 325 (i.e., FIG. 19) extending respectively between stanchions 317, 319, and 321 (i.e., FIG. 18) and stanchions 312, 314, and 316 (i.e., FIG. 18). Each horizontal upper strut 323, 324 and 325 has a corresponding pair of smaller, parallel struts disposed beneath it. For example, strut 323 has smaller struts 360 and 361 beneath it (i.e., FIG. 18). Strut 324 has smaller struts 362 and 363 beneath it (FIG. 18.) Strut 325 has axially aligned struts 364 and 365 parallel with it and beneath it.

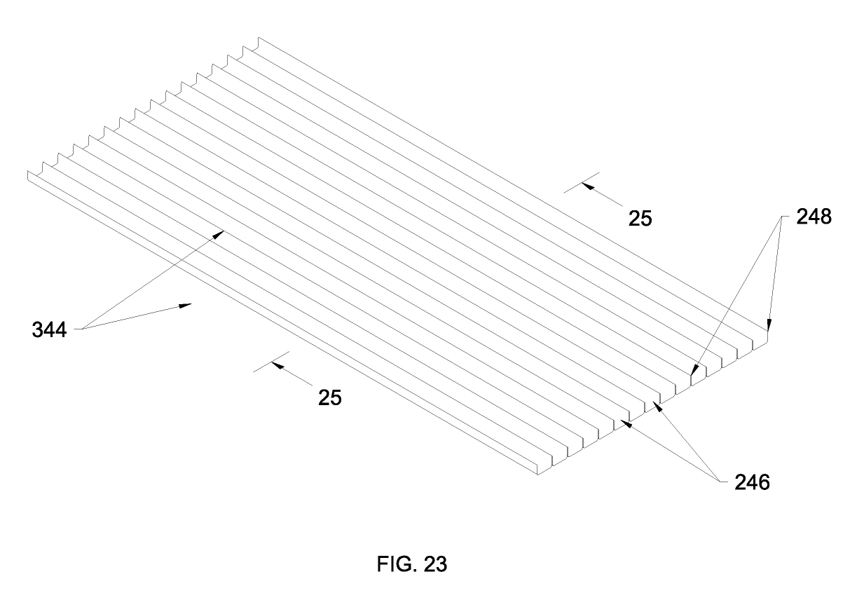

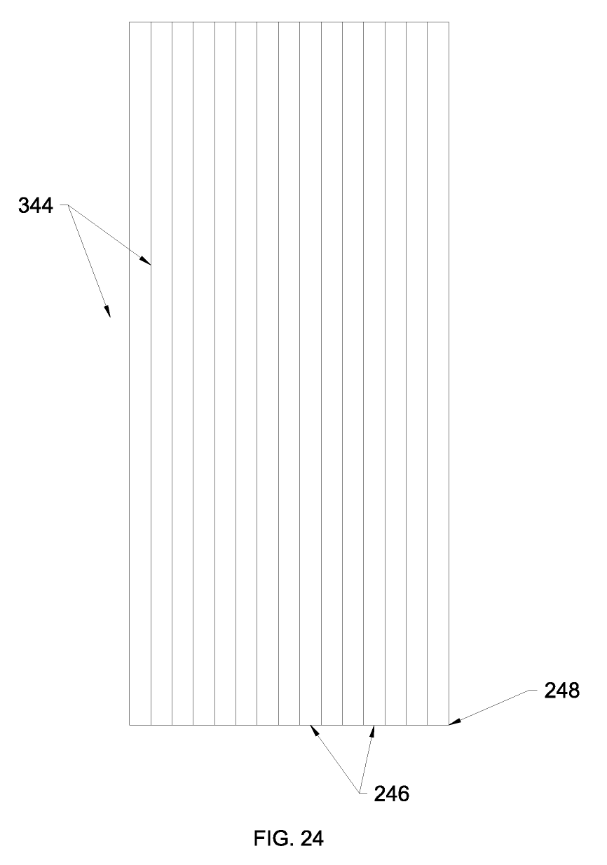

As viewed in FIG. 19, frame 302 comprises a plurality of horizontal, spaced apart frame members 340 (FIGS. 19) and 342 (FIG. 18) that transversely extend across and between the sides 311 (FIGS. 19) and 313 of frame 302 beneath the elevated frame structure 310. Transverse frame members 340, 342 support generally rectangular, channeled floors 344 and 345 (i.e., FIG. 19) that are horizontally oriented. The upper struts 360-365 discussed above support channeled ceilings 369 and 370 (FIG. 18), that are horizontally oriented and spaced apart from and parallel with the lower floors 344, 345. Floors 344, 345 and ceilings 369, 370 are constructed similarly. Each has a plurality of elongated, parallel channels that are aligned in opposed ceilings and floors to slidably receive and support the fence panels 24 for transportation. Upper and lower portions of the panels are slidably captivated within aligned channels (i.e., channel 246 in FIG. 24) defined between vertically rising ridges 248 (FIG. 23), and the panels 24 are thus transported in a stable, semi-permanent vertical orientation.

Preferably the gate 26 discussed earlier is also vertically stored within trailer 300 for transportation (i.e., FIG. 20). For safe and stable stowage, the gate assembly is preferably disposed in parallel with the fence panels 24. A rigid, elongated, channel 350 extends along the bottom of the trailer 300, spaced apart from and parallel with floors 344 (FIG. 20). A similar rigid channel 352 is disposed at the trailer top parallel within the ceilings 369, 370 (FIG. 18). When being transported, the gate 26, with trap door 28 nested therewithin, can be secured between and within channels 350 and 352 in a stable vertical orientation spaced apart from, and parallel with the similarly vertically stored fence modules 24.

FIG. 26 shows a circuit 400 for cellular phone control, without a GSM unit. Cellular trap controller 400 uses a separate cellular modem and router. A battery 401 powered by solar panel charger 402 from the solar panel 100 supplies the power supply 404. The cellular antenna 106 feeds the cellular modem 408 that connects to a router 410 that leads to a dispenser/feeder 412 (Ice., dispenser 25 discussed above). The feeder is activated with a relay that supplies power to the feeder/dispenser 25 which in turn distributes feed or animal attractant. The router is connected to a “power over Ethernet” stage 414 that powers camera 420. A gate switch 416 controls camera acts via gate activation relay 418 to control solenoid 75 and plunger 77 (FIG. 15) instead of the GSM unit. Infrared light is supplied by source 422 for night vision. Power supply 404 powers the last mentioned components via a line 424. Solenoid 75 and thus plunger 77 (FIG. 15) are controlled by this apparatus instead of a GSM unit.

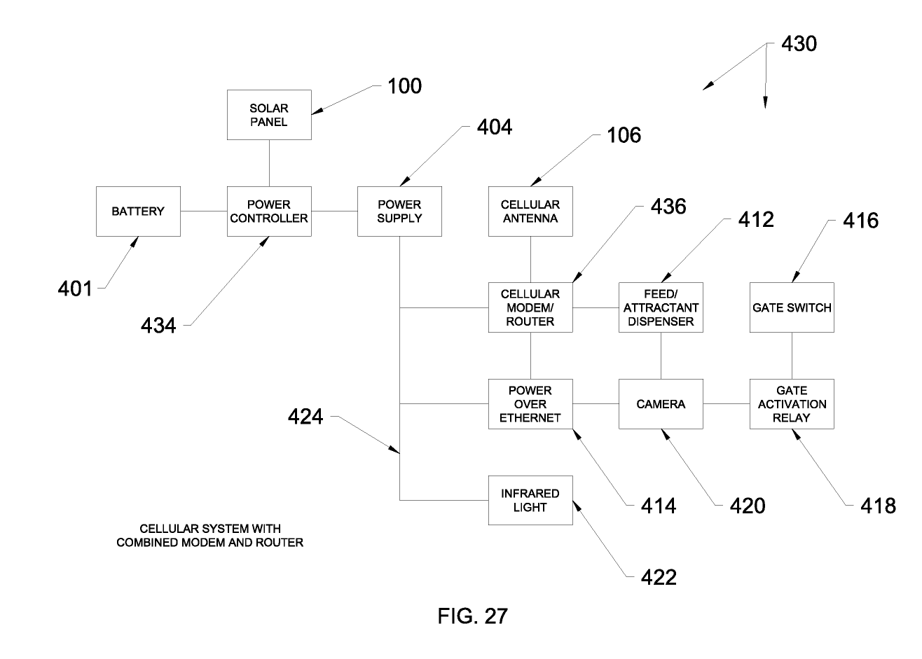

The trap controller circuit 430 (FIG. 27) is similar to the arrangement of FIG. 26. System 430 is also for cell phone use, but has no GSM unit like system 400. Solar panel 100 and battery 401 lead to a power controller connected to power supply 404 that outputs on line 424. In this case the previously described modem 408 and router 410 are combined in a single cellular modem router 436 (FIG. 27) that replaces blocks 408 and 410 in FIG. 26. Solenoid 75 and thus plunger 77 (FIG. 5) are controlled by this apparatus instead of a GSM unit.

A similar controller circuit 440 (FIG. 28) uses a satellite system with a separate modem and router. Again, component power is supplied on line 424 from power controller 434 connected to power supply 404. The satellite antenna dish 108 is connected to a satellite modem 445 leading to a router 446. The other components are similar to that described above. Solenoid 75 and thus plunger 77 (FIG. 15) are controlled by this apparatus instead of a GSM unit.

In FIG. 29 a controller circuit 450 uses a cellular GSM relay switch 454. Mechanically it is illustrated in FIG. 15 discussed above. It is controlled by gate switch 456 and leads to feeder 457.

A user monitoring the trap watching pictures or video can determine trap status. Once logged into the camera, a user can determine if they are ready to capture animals. Pressing a button on the camera control screen activates the gate latch mechanism which closes the gate and captures the animals.

The feeder/attractant dispenser would be controlled in a similar manner with a button on the camera control screen. The function is basically the same with a relay that gets activated supplying power to the feeder/dispenser which in turn distributes feed or animal attractant.

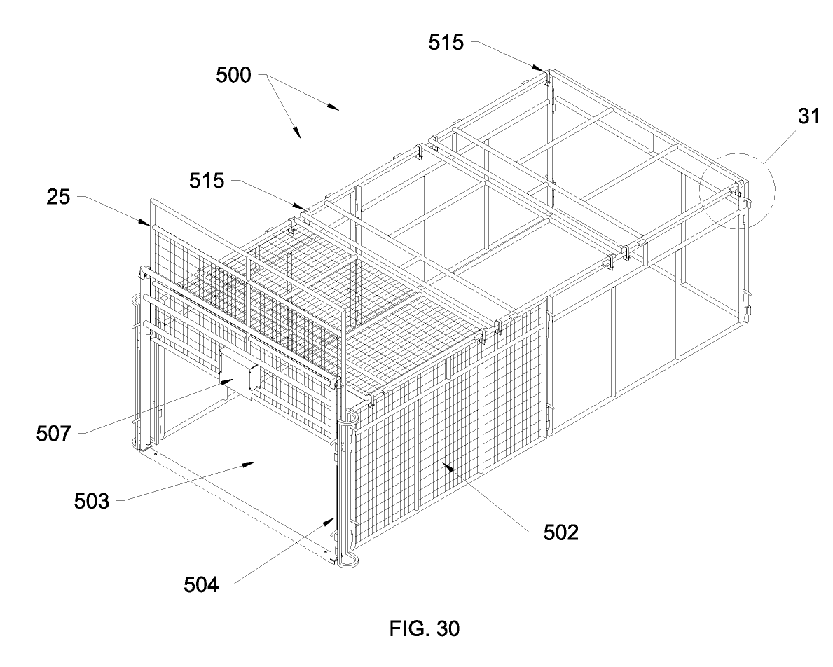

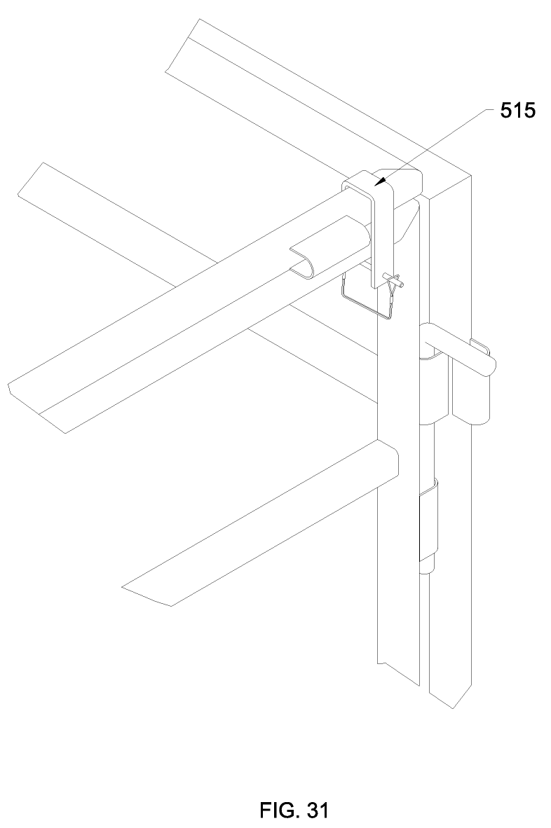

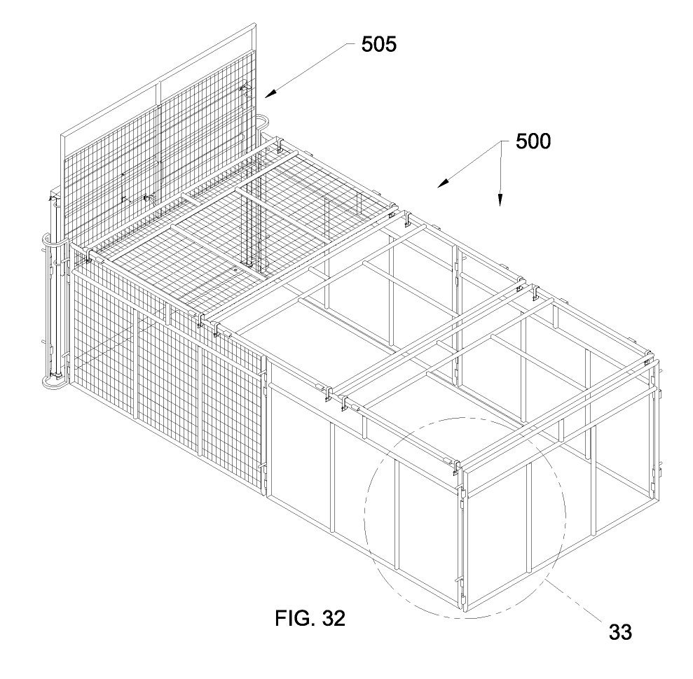

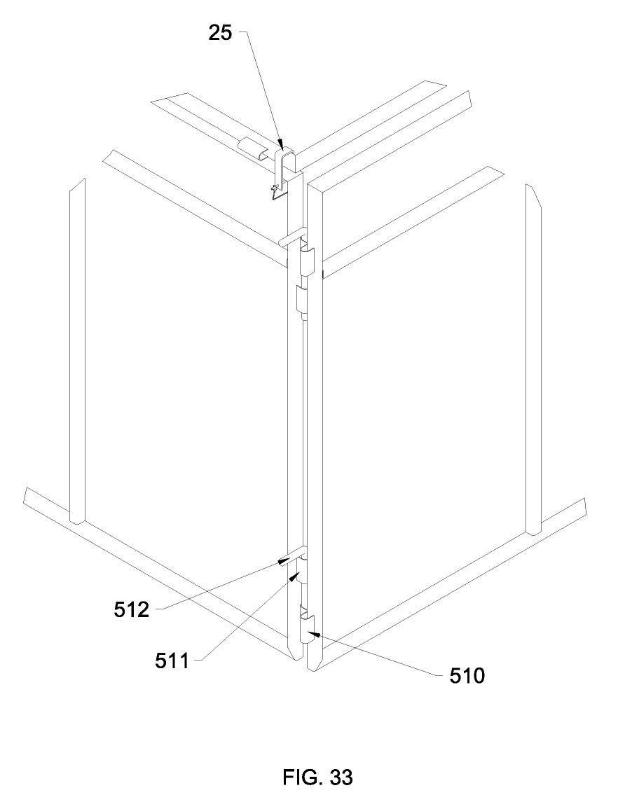

FIG. 30 shows a corral 500 that is made from multiple panels 502 that are similar to panels 24 discussed above. However, the panels 502 are equipped with modifications so that they may be attached across an enclosed volume to provide a roof, completely enclosing the trap. As before, there is an opening 503 defined by the gate structure 504 that can be closed by dropping trap door 505 with the electronics discussed above, that releases actuator 507. As best seen in FIG. 31, the panels are fastened edgewise as before with their aligned sleeves 510 and 511 being pinned by pins 512, and they can be held atop aligned lower vertical panels in a horizontal orientation by a U-shaped clamp 515.

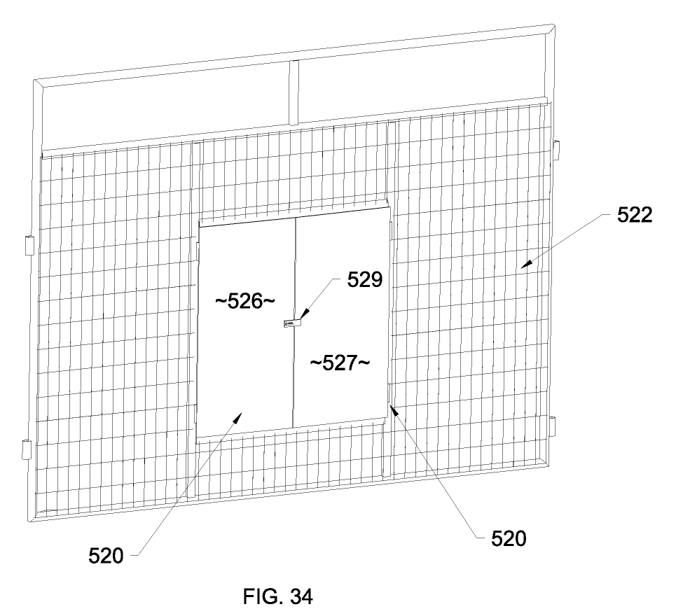

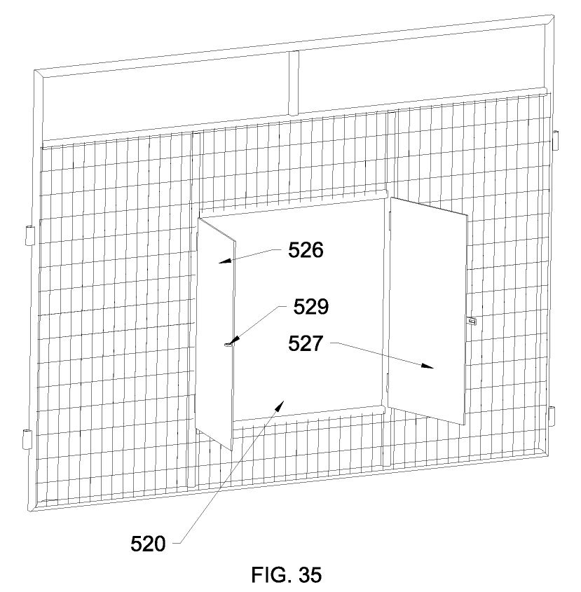

FIG. 34 shows a two piece, flat foldable door 520 disposed within the framework of a panel 522. Each half 526 and 527 is secured by a latch 529. In FIG. 35 the door is open

From the foregoing, it will be seen that this invention is one well adapted to obtain all the ends and objects herein set forth, together with other advantages which are inherent to the structure.

It will be understood that certain features and subcombinations are of utility and may be employed without reference to other features and subcombinations.

As many possible embodiments may be made of the invention without departing from the scope thereof, it is to be understood that all matter herein set forth or shown in the accompanying drawings is to be interpreted as illustrative and not in a limiting sense.

What is claimed is:

1. A portable animal trap comprising:
a modular corral adapted to be transported to and assembled at a trapping site for capturing and restraining animals, the corral comprising a plurality of generally rectangular fence panels for constructing a corral at a selected trapping location;
each fence panel comprising means for removably, pivotally coupling the panel to adjacent panels when the corral is deployed;
at least one gate adapted to be coupled between adjoining fence panels that establishes a corral entryway, the gate supporting a trap door proximate said entryway that, when open, allows animal access into said corral and which, when closed, prevents animal escape from said corral, the gate comprising a pair of spaced-apart sides between which the trap door is slidably captivated;
the trap door comprising a catch;
a latch for engaging said catch to maintain said trap door open;
a controller responsive to remote signals for releasing the latch to capture animals within said corral; and,
a remotely viewable video camera for monitoring said trapping location.

2. The animal trap as defined in claim 1 wherein the controller is a GSM controller responsive to cell phone instructions for releasing the trap door.

3. The animal trap as defined in claim 2 further comprising a circuit for operating the GSM controller and said video camera.

4. The animal trap as defined in claim 2 wherein said circuit comprises a relay operated by said GSM and linked to said latch.

5. The animal trap as defined in claim 4 wherein said circuit comprises a power supply comprising a battery, a solar panel for recharging, and an infrared light source for illuminating the coral during darkness.

6. The animal trap as defined in claim 1 wherein the controller is responsive to satellite relayed Ethernet instructions for releasing the trap door.

7. The animal trap as defined in claim 6 further comprising a circuit for operating the said video camera.

8. The animal trap as defined in claim 6 wherein said circuit comprises a satellite dish for receiving instructions, a satellite modem, and a router for activating said latch via Internet.

9. The animal trap as defined in claim 8 wherein said circuit comprises a power supply comprising a battery, a solar panel for recharging, and an infrared light source for illuminating the corral during darkness.

10. The animal trap system as defined in claim 1 further comprising mobile platform means for transporting said corral, said platform means comprising a floor with a plurality of elongated, spaced apart and parallel channels, a ceiling with a plurality of elongated, spaced apart and parallel channels, and wherein the ceiling channels are aligned with the floor channels whereby fence panels may be vertically, slidably secured between aligned ceiling and floor channels for transportation.

11. The animal trap system as defined in claim 10 wherein the mobile platform means comprises first and second vertically spaced apart and parallel gate channels for slidably receiving the gate for stowage parallel to stowed fence panels.

12. A portable animal trap comprising:
a modular corral adapted to be transported to and assembled at a trapping site for capturing and restraining animals, the corral comprising a plurality of generally rectangular fence panels for constructing a corral at a selected trapping location;
each fence panel comprising an anti-climbing void and means for removably, pivotally coupling the panel to adjacent panels when the corral is deployed;
at least one gate adapted to be coupled between adjoining fence panels that establishes a corral entryway, the gate supporting a trap door proximate said entryway that, when open, allows animal access into said corral and which, when closed, prevents animal escape from said corral, the gate comprising a pair of spaced-apart sides between which the trap door is slidably captivated;
the trap door comprising a catch;
a latch for selectively maintaining said trap door open by engaging said catch, and selectively operable to drop trap door to close said trap;
a controller for operating said latch, said controller responsive to remote signals for releasing the latch to capture animals within said corral; and,
a remotely viewable video camera for monitoring said trapping location.

13. The animal trap as defined in claim 12 wherein the controller is a GSM controller responsive to cell phone instructions for releasing the trap door.

14. The animal trap as defined in claim 13 further comprising a relay operated by said GSM controller for triggering said latch.

15. The animal trap as defined in claim 12 wherein wherein said controller comprises a relay switch.

16. The animal trap as defined in claim 15 wherein said circuit comprises a satellite dish for receiving instructions, a satellite modem, and a router for activating said latch via Internet.

17. The animal trap system as defined in claim 12 further comprising mobile platform means for transporting said corral, said platform means comprising a floor with a plurality of elongated, spaced apart and parallel channels, a ceiling with a plurality of elongated, spaced apart and parallel channels, and wherein the ceiling channels are aligned with the floor channels whereby fence panels may be vertically, slidably secured between aligned ceiling and floor channels for transportation.

18. The animal trap system as defined in claim 17 wherein the mobile platform means comprises first and second vertically spaced apart and parallel gate channels for slidably receiving the gate for stowage parallel to stowed fence panels.
